(19) United States
(12) Patent Application Publication
(10) Pub. No.: US 2026/0302082 A1
(43) Pub. Date: Oct. 1, 2026

(54) MULTILAYER CERAMIC ELECTRONIC COMPONENT

(71) Applicant: TAIYO YUDEN CO., LTD., Tokyo (JP)

(72) Inventor: Yuta SAITO, Tokyo (JP)

(21) Appl. No.: 19/572,063

(22) Filed: Mar. 19, 2026

(30) Foreign Application Priority Data
Mar. 31, 2025 (JP) 2025-059364

(51) Int. Cl. H01G 4/30; H01G 4/12

(52) U.S. Cl. CPC H01G 4/30; H01G 4/1227

(57) ABSTRACT

A multilayer ceramic electronic component includes a base body including dielectric layers and internal electrode layers alternately stacked along a first axis. The internal electrode layers are led to an outside of the base body from either end along a second axis perpendicular to the first axis. The base body has a side margin at both ends along a third axis perpendicular to the first axis and to the second axis. In a cross-sectional image taken along the first axis, the side margin includes particles of a secondary phase and particles of a dielectric material. Each of the particles of the secondary phase has a surface of a length of 2 μm or greater. An average number of the particles of the dielectric material in contact with the surface of each of the particles of the secondary phase per 1 μm is 0.5 or greater and 5 or less.

### CROSS-REFERENCE TO RELATED APPLICATIONS

This patent application is based on and claims priority to Japanese Patent Application No. 2025-059364 filed on Mar. 31, 2025, the entire contents of which are incorporated herein by reference.

### TECHNICAL FIELD

The present disclosure relates to multilayer ceramic electronic components.

### BACKGROUND

A multilayer ceramic electronic component has a structure in which dielectric layers and internal electrode layers are alternately stacked. Examples of the multilayer ceramic electronic component include a multilayer ceramic capacitor (MLCC), and the like.

Multilayer ceramic electronic components, such as multilayer ceramic capacitors, are mounted and used in various electronic devices, such as high-frequency communication systems represented by mobile phones, in-vehicle electronic control devices, and the like. Therefore, there is a demand for multilayer ceramic electronic components to have improved performance in various areas, and studies have been conducted on such multilayer ceramic electronic components (see, for example, Patent Document 1).

### RELATED ART DOCUMENT

### Patent Document

Patent Document 1: Japanese Laid-Open Patent Application Publication No. H08-45768

### SUMMARY

The multilayer ceramic electronic component of the present disclosure includes:
a base body in which dielectric layers and internal electrode layers are alternately stacked along a first axis,
wherein the internal electrode layers are led to an outside of the base body from either end of the base body along a second axis perpendicular to the first axis,
the base body has a side margin at both ends of the base body, the both ends of the base body being along a third axis perpendicular to the first axis and to the second axis, and
in a cross-sectional image of the multilayer ceramic electronic component taken along the first axis, the side margin includes particles of a secondary phase and particles of a dielectric material, where each of the particles of the secondary phase has a surface of a length of 2 μm or greater, and an average number of the particles of the dielectric material in contact with the surface of each of the particles of the secondary phase per 1 μm is 0.5 or greater and 5 or less.

### BRIEF DESCRIPTION OF THE DRAWINGS

FIG. 1 is a partial cross-sectional perspective view illustrating an example of a multilayer ceramic capacitor according to one embodiment of the present disclosure;

FIG. 2 is a cross-sectional view illustrating an example of the multilayer ceramic capacitor according to one embodiment of the present disclosure;

FIG. 3 is a cross-sectional view illustrating an example of the multilayer ceramic capacitor according to one embodiment of the present disclosure;

FIGS. 4A and 4B are cross-sectional views illustrating an example of the details of a side margin in the multilayer ceramic capacitor according to one embodiment of the present disclosure;

FIG. 5 is a flowchart illustrating an example of a production method for the multilayer ceramic capacitor according to one embodiment of the present disclosure; and

FIGS. 6A and 6B are views illustrating an example of the production method for the multilayer ceramic capacitor according to one embodiment of the present disclosure.

### DETAILED DESCRIPTION

As described above, multilayer ceramic electronic components are mounted in various electronic devices, and improved performance in various areas is desired. Depending on the installation environment, the multilayer ceramic electronic component may fail due to humidity in the air. Therefore, there is an increasing demand for a multilayer ceramic electronic component having excellent moisture resistance.

The present disclosure aims to provide a multilayer ceramic electronic component having excellent moisture resistance.

Hereinafter, embodiments of the present disclosure will be described in detail, but the present disclosure is not limited to these embodiments. In the present specification and drawings, constituent components having a substantially same functional configuration are denoted by the same reference numerals, and redundant description may be omitted. In the drawings, an X-axis, a Y-axis, and a Z-axis that are perpendicular to one another are illustrated as appropriate. The X-axis, the Y-axis, and the Z-axis define a fixed coordinate system that is fixed with respect to a multilayer ceramic capacitor, which is an example of the multilayer ceramic electronic component. In the case where an outer shape of the multilayer ceramic capacitor, which is an example of the multilayer ceramic electronic component, is a substantially rectangular parallelepiped, the X-axis, the Y-axis, and the Z-axis may correspond to a length, width, and height of the multilayer ceramic capacitor. All the drawings are schematic views for exemplifying the configurations, and the size, scale, or the like may not be accurately illustrated in the drawings. In particular, due to page size limitations, it is difficult to accurately illustrate the number of internal electrode layers or dielectric layers, thus the number of the internal electrode layers or dielectric layers may be greater or less than the number of the layers illustrated in the drawings.

The multilayer ceramic electronic component of the present embodiment will be described hereinafter through a multilayer ceramic capacitor, which is one example of the multilayer ceramic electronic component.

### [Multilayer Ceramic Electronic Component]

### (1) Configuration of Multilayer Ceramic Electronic Component

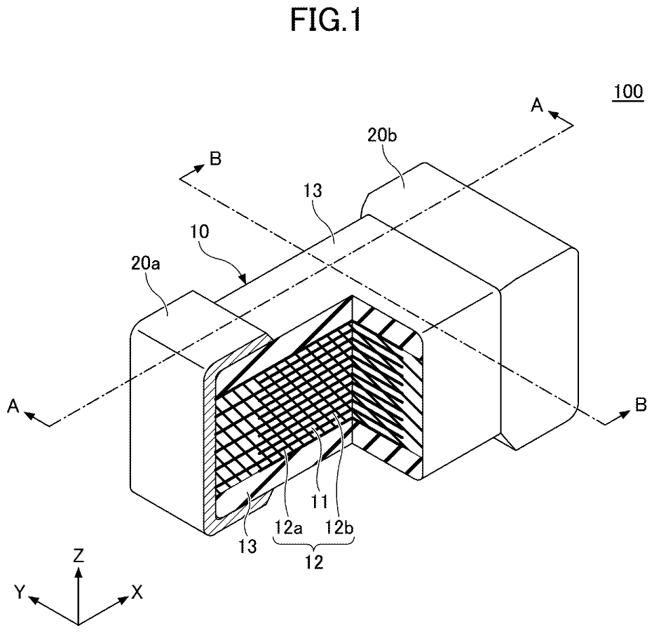

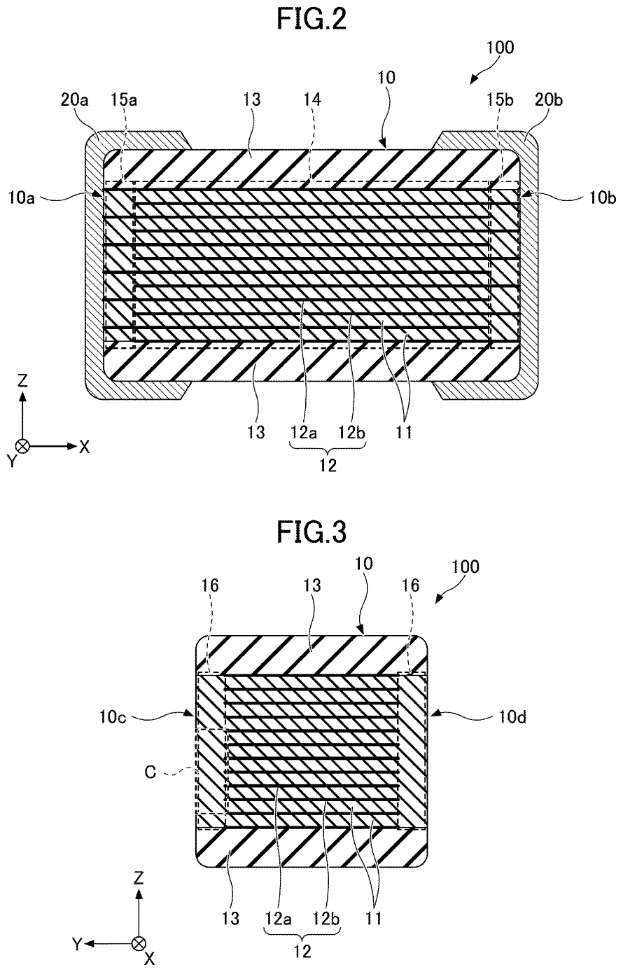

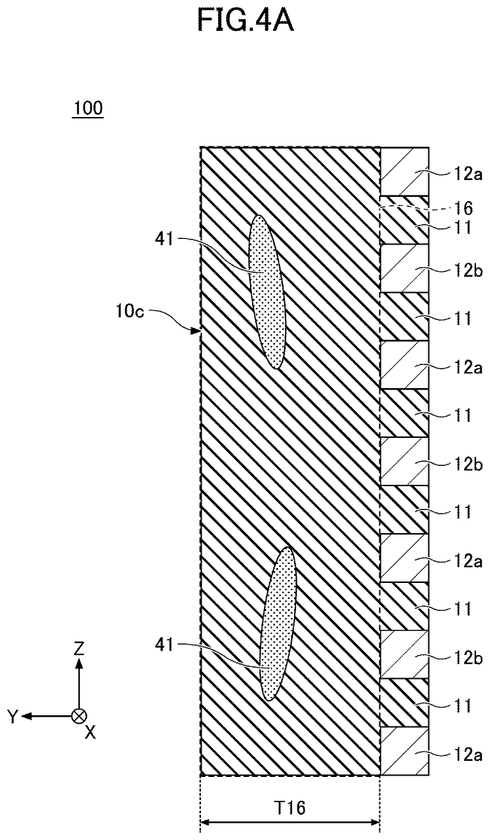

FIG. 1 is a partial cross-sectional perspective view illustrating an example of the multilayer ceramic capacitor 100. FIGS. 2 and 3 are cross-sectional views illustrating an example of the multilayer ceramic capacitor. FIG. 2 is a cross-sectional view taken along the line A-A in FIG. 1. FIG. 3 is a cross-sectional view taken along the line B-B in FIG. 1. As illustrated in FIGS. 1 to 3, the multilayer ceramic capacitor 100 includes a base body 10 having a substantially rectangular parallelepiped shape. Two surfaces of the base body 10 facing each other are referred to as an upper surface and a lower surface, and four surfaces connecting between the upper surface and the lower surface are referred to as side surfaces. In general, the surface of the multilayer ceramic capacitor facing a circuit board when the multilayer ceramic capacitor is mounted on the circuit board is referred to as a lower surface, but the orientation of the surfaces is not limited to the above. In the example illustrated in FIGS. 1 to 3, a first external electrode 20a and a second external electrode 20b are disposed on a first side surface 10a and a second side surface 10b (see FIG. 2), respectively, which are two side surfaces of the base body 10 facing each other. The first external electrode 20a extends from the first side surface 10a to four adjacent surfaces. The second external electrode 20b extends from the second side surface 10b to four adjacent surfaces. However, the first external electrode 20a and the second external electrode 20b are separated from each other. The external electrodes may be provided on any surfaces of the base body 10, and the positions of the external electrode to be disposed are not limited to the two side surfaces.

The stacking direction along which the dielectric layers 11 and the internal electrode layer 12 are stacked is a first axis. In FIGS. 1 to 3, the first axis, which is the stacking direction of the dielectric layers 11 and the internal electrode layers 12, is the Z-axis, and is the direction in which the internal electrode layers face one another.

An axis perpendicular to the first axis that is the stacking direction is a second axis. In FIGS. 1 to 3, the second axis, which is the axis perpendicular to the first axis as the stacking direction, is the X-axis. The second axis is an axis along the length direction of the base body 10, and is an axis along the direction in which the first side surface 10a and the second side surface 10b of the base body 10 face each other, or an axis along the direction in which the first external electrode 20a and the second external electrode 20b face each other.

An axis perpendicular to the first axis as the stacking direction, and to the second axis is a third axis. The third axis is an axis along the width direction of the internal electrode layers 12. In FIGS. 1 to 3, the third axis, which is perpendicular to the first axis as the stacking direction and to the second axis, is the Y-axis. The third axis is an axis along the direction in which a third side surface 10c and a fourth side surface 10d face each other (see FIG. 3). The third side surface 10c and the fourth side surface 10d are two side surfaces other than the first side surface 10a and the second side surface 10b, among the four side surfaces of the base body 10. The X-axis, the Y-axis, and the Z-axis are perpendicular to one another.

The stacking direction is not limited to the Z-axial direction, and may be any direction. Thus, the first axis, which is the stacking direction, may be the X-axis in the X-axial direction or the Y-axis in the Y-axial direction.

In the present specification, for the purpose of describing a general embodiment, a drawing illustrating a specific embodiment may be used. However, the features described using the coordinate axis system in one embodiment may be applied to a general embodiment by replacing the coordinate axis system with a general coordinate axis system in which the stacking direction is the first axis. For example, the features described as the X-axis, the Y-axis, and the Z-axis, and are used in FIGS. 1 to 3 in which the stacking direction is matched with the Z-axial direction as a specific one embodiment are applied to the general embodiments by replacing the X-axis, the Y-axis, and the Z-axis with the second axis, the third axis, and the first axis, respectively.

The base body 10 has a configuration in which dielectric layers 11 and internal electrode layers 12 are alternately stacked. Each of the dielectric layers 11 includes, as a main component, a ceramic material functioning as a dielectric. Each of the dielectric layers 11 may include particles of a dielectric material as the ceramic material, and may further include a secondary phase. The internal electrode layers 12 include first internal electrode layers 12a and second internal electrode layers 12b. The first internal electrode layers 12a and the second internal electrode layers 12b are alternately stacked. The end edges of the first internal electrode layers 12a are led to the surface of the base body 10 on which the first external electrode 20a is disposed, i.e., the first side surface 10a in the example illustrated in FIGS. 1 to 3. The end edges of the second internal electrode layers 12b are led to the surface of the base body 10 on which the second external electrode 20b is disposed, i.e., the second side surface 10b in the example illustrated in FIGS. 1 to 3. Specifically, the internal electrode layers 12 are led to an outside of the base body from either end of the base body along the X-axis, which is the second axis. Thus, the first internal electrode layers 12a and the second internal electrode layers 12b are alternately electrically connected to the first external electrode 20a and the second external electrode 20b, respectively. Thus, the multilayer ceramic capacitor 100 has a structure in which capacitor units are stacked. In addition, in the multilayer stack including the dielectric layers 11 and the internal electrode layers 12, outermost layers of the multilayer stack in the stacking direction are internal electrode layers 12, and the outer surfaces of the multilayer stack, i.e., the upper surface and the lower surface in the example of FIGS. 1 and 3, are covered with cover layers 13, respectively. Each of the cover layers 13 includes a ceramic material as a main component. For example, the composition of each of the cover layers 13 may be same as or different from the composition of each of the dielectric layers 11. The configuration of the multilayer ceramic capacitor 100 is not limited to the configuration illustrated in FIGS. 1 to 3, as long as the first internal electrode layers 12a and the second internal electrode layers 12b are led to different regions of the surfaces of the multilayer stack. The different regions of the surfaces of the multilayer stack may be regions of surfaces of the multilayer stack facing each other, regions of surfaces of the multilayer stack adjacent to each other, or different regions in the same surface of the multilayer stack. Each of the external electrodes may be extended from the surface having the corresponding surface region of the multilayer stack, to which the first internal electrode layers 12a or the second internal electrode layers 12b are exposed, to other surfaces, as long as the individual external electrodes are separated from each other.

As illustrated in FIG. 2, the portion in which the first internal electrode layers 12a connected to the first external electrode 20a and the second internal electrode layers 12b connected to the second external electrode 20b face each other is the portion of the multilayer ceramic capacitor 100 in which a capacitance is generated. Therefore, the portion in which a capacitance is generated is referred to as a capacitance portion 14. Specifically, the capacitance portion 14 is a portion in which each of the internal electrode layers connected to one external electrode and each of the internal electrode layers connected to the other external electrode, which are adjacent to each other via a dielectric layer 11, face each other via the dielectric layers 11.

The region in which the first internal electrode layers 12a connected to the first external electrode 20a face one another in the stacking direction without interposition of the second internal electrode layers 12b connected to the second external electrode 20b is referred to as a first end margin 15a (see FIG. 2). Moreover, the region in which the second internal electrode layers 12b connected to the second external electrode 20b face one another in the stacking direction without interposition of the first internal electrode layers 12a connected to the first external electrode 20a is referred to as a second end margin 15b.

Each of the end margins is a region in which the internal electrode layers connected to the same external electrode face one another in the stacking direction without interposition of the internal electrode layers connected to the different external electrode. Each of the first end margin 15a and the second end margin 15b is a region in which the internal electrode layers having the same potential face one another, and a capacitance is not substantially generated. The end margins may include a ceramic material as a main component. For example, the composition of each of the end margins may be same as or different from the composition of each of the dielectric layers 11.

The side margin 16 is a region disposed at an outside of the capacitance portion 14 with respect to the third axis that is perpendicular to the stacking direction and to the second axis, i.e., in the direction along the Y-axis in the example illustrated in FIG. 3. Specifically, the side margin 16 is an outer region adjacent to the capacitance portion 14 as viewed in the stacking direction, and is an outer region adjacent to the capacitance portion 14 on the sides of the capacitance portion 14 where the internal electrode layers 12 are not led to the outside of the base body. The side margin 16 is also a region in which a capacitance is not generated. The side margin 16 may include a ceramic material as a main component. For example, the composition of the side margin 16 may be same as or different from the composition of each of the dielectric layers 11. As described later, the side margin 16 may include, in addition to the dielectric material, a secondary phase having the composition different from the dielectric material.

The dimensions of the multilayer ceramic capacitor 100 are not particularly limited. For example, the dimensions of the multilayer ceramic capacitor 100 may be: 0.25 mm in length, 0.125 mm in width, and 0.125 mm in height; 0.4 mm in length, 0.2 mm in width, and 0.2 mm in height; 0.6 mm in length, 0.3 mm in width, and 0.3 mm in height; 1.0 mm in length, 0.5 mm in width, and 0.5 mm in height; 3.2 mm in length, 1.6 mm in width, and 1.6 mm in height; or 4.5 mm in length, 3.2 mm in width, and 2.5 mm in height. However, the dimensions of the multilayer ceramic capacitor 100 listed above are merely examples, and the multilayer ceramic capacitor is not limited to the above dimensions. The dimensions of the multilayer ceramic capacitor 100 may satisfy, for example, length>width≥height, width>length≥height, height>length≥width, or height>width≥length. For example, the length indicates the dimension in the X-axial direction, the width indicates the dimension in the Y-axial direction, and the height indicates the dimension in the Z-axis direction.

As has been described above, the multilayer ceramic capacitor 100 of the present embodiment includes the base body 10 in which the dielectric layers 11 and the internal electrode layers 12 are alternately stacked along the Z-axis that is the first axis.

Moreover, the internal electrode layers 12 can be led to the outside of the base body 10 from either end of the base body 10 along the X-axis, which is the second axis perpendicular to the first axis, i.e., the first side surface 10a or the second side surface 10b.

The base body 10 has the side margin 16 at both ends of the base body along the Y-axis, which is the third axis perpendicular to the first axis and to the second axis.

Each constituent component will be described hereinafter.

In the present specification, numbers, such as first and second, may be added to names of members, such as first internal electrode layers and second internal electrode layers. However, these numbers are merely added by specifying members to be described and avoiding confusion, and do not indicate the priority, arrangement, and the like. Therefore, the members may be simply described as the names of the members, such as internal electrode layers, when there is no possibility of confusion, or when the members are collectively referred to.

### (2) Dielectric Layer

Each of the dielectric layers 11 may include a dielectric material. Each of the dielectric layer 11 may include dielectric material particles serving as the dielectric material as a main component, i.e., being included at the largest ratio based on the amount of substance, relative to all substances included in the dielectric layer 11. In addition to the dielectric material particles, each of the dielectric layers 11 may include a secondary phase derived from the below-described additive compound or a reaction product of the additive compound. Each of the dielectric layers 11 may include, for example, a compound having a perovskite structure, which includes an element A and an element B and is represented by a general formula ABO_{3-α} (0≤α≤1), as the dielectric material. In the general formula, A and B represent elements at the A-site and the B-site, respectively.

### (2-1) Compound Having Perovskite Structure

In stoichiometry, α, which is an amount deviated from stoichiometry, becomes 0, and the compound having the perovskite structure is represented by a general formula ABO₃. The compound having the perovskite structure represented by the above general formula may have α of greater than 0 and 1 or less. Specifically, the compound having the perovskite structure represented by the above general formula may have oxygen deficiency compared with the composition of stoichiometry.

As the compound having the perovskite structure, at least one selected from the group consisting of barium titanate (BaTiO₃), calcium zirconate (CaZrO₃), calcium titanate (CaTiO₃), strontium titanate (SrTiO₃), magnesium titanate (MgTiO₃), Ba_{1-x-y}CaₓSr_{y}Ti_{1-z}Zr₂O₃ (0≤x≤1, 0≤y≤1, 0≤z≤1) forming a perovskite structure, and the like can be used.

Ba_{1-x-y}CaₓSr_{y}Ti_{1-z}Zr₂O₃ is barium strontium titanate, barium calcium titanate, barium zirconate, barium zirconate titanate, calcium zirconate titanate, barium calcium zirconate titanate, or the like. Any of the above materials for the compound having the perovskite structure may include oxygen deficiency.

In view of particularly excellent dielectric characteristics, each of the dielectric layers 11 preferably includes barium titanate as the compound having the perovskite structure, may include barium titanate as a main component, or may be composed of barium titanate. Barium titanate has excellent dielectric characteristics, such as an extremely high dielectric constant and a small dielectric loss. Therefore, when the dielectric layers 11 include barium titanate as the compound having the perovskite structure, a capacitance of the multilayer ceramic capacitor 100 is increased. In the present specification, “include as a main component” means that the mentioned substance is included at the largest ratio based on the amount of substance relative to all the substances included.

In addition, the compound having the perovskite structure may be included as a main component in each of the dielectric layers 11. Each of the dielectric layers 11 may include the compound having the perovskite structure, for example, in the amount of 50 mol % or greater, or 90 mol % or greater.

### (Additive Compound)

Each of the dielectric layers 11 may include an additive compound as an optional component.

The additive compound that may be included in each of the dielectric layers 11 is not particularly limited. Examples of the additive compound include: any of oxides, carbonates, or nitrides each including at least one element selected from the group consisting of zirconium (Zr), magnesium (Mg), manganese (Mn), molybdenum (Mo), vanadium (V), chromium (Cr), aluminum (Al), titanium (Ti), calcium (Ca), and rare-earth elements; any of oxides, carbonates, or nitrides each including at least one element selected from the group consisting of cobalt (Co), nickel (Ni), lithium (Li), boron (B), sodium (Na), potassium (K), and silicon (Si); glass including at least one element selected from the group consisting of cobalt, nickel, lithium, boron, sodium, potassium, and silicon; and the like.

The rare-earth elements are not particularly limited, and at least one selected from the group consisting of scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb) can be used.

### (2-2) Thickness of Dielectric Layer

The thickness of each of the dielectric layers 11 is not particularly limited. From the viewpoint of an increase in capacitance through an increase in number of layers to be stacked, while reducing the size of the multilayer ceramic capacitor 100, the thickness of each of the dielectric layers 11 may be, for example, 1.0 μm or less, 0.8 μm or less, 0.5 μm or less, or 0.4 μm or less.

The lower limit of the thickness of each of the dielectric layers 11 is not particularly limited. From the viewpoint of an increase in productivity or yield, the minimum thickness can be 2 times to 4 times the average diameter of the dielectric material particles to be used. For example, in the case where the average particle diameter of the dielectric material particles to be used is 0.1 μm, the lower limit of the thickness of each of the dielectric layers 11 may be 0.2 μm or greater and 0.4 μm or less. For example, the thickness of each of the dielectric layers 11 may be 0.2 μm or greater, or 0.4 μm or greater.

An average particle diameter of the dielectric material particles may be determined as follows. In the cross-section of the multilayer ceramic capacitor 100 taken along the first axis that is the stacking direction, the particle diameter of each of the dielectric material particles is measured, and an average value of the measured diameters is determined as the average particle diameter. For the measurement of the particle diameters of the dielectric material particles, an optical microscope, a microscope, a scanning electron microscope (SEM), or the like can be appropriately used. The particle diameter of each of the dielectric material particles can be the Heywood diameter (a diameter of a circle having an area equal to the area of the dielectric material particle to be evaluated) in the observed cross-section. An average particle diameter, which is an average value of the particle diameters of the dielectric material particles, can be the arithmetic mean of the particle diameters of 50 dielectric material particles or more and 200 dielectric material particles or less. In the present specification, an average value is an arithmetic mean, unless otherwise specified.

The thickness of each of the dielectric layers 11 is evaluated in the cross-section taken along the first axis that is the stacking direction. For example, the evaluation is performed in the cross-section taken along the second axis perpendicular to the stacking direction, as well as the first axis, or a cross-section taken along the third axis perpendicular to the stacking direction and to the second axis, as well as the first axis, in view of easiness of polishing and measuring. The former is obtained by polishing the multilayer ceramic capacitor 100 in the third axis direction, and the latter is obtained by polishing the multilayer ceramic capacitor 100 in the second axis direction. Among the exposed dielectric layers 11, five layers are selected from each of the center portion, the upper portion, and the lower portion of the multilayer ceramic capacitor 100 in the first axis direction. In the case where the total number of the dielectric layers 11 is an even number, six layers are selected from the center portion. A thickness of each of the selected dielectric layers was measured at three positions in total, i.e., a center, a left side edge, and a right side edge of the given dielectric layer, and an average value of the measured thickness values is determined as the thickness of the given dielectric layer 11. Then, an average value of the thickness values of all the selected and evaluated dielectric layers 11 is determined as the thickness of each of the dielectric layers 11 of the multilayer ceramic capacitor 100.

Since the first axis that is the stacking direction is the Z-axial direction in the example illustrated in FIGS. 1 and 2, the multilayer ceramic capacitor 100 is polished along the Y-axis that is the third axis to expose the XZ plane revealing the stacking of the dielectric layers 11 and the internal electrode layers 12.

In this case, within the exposed XZ plane, five dielectric layers 11 located at the center portion along the Z-axis that is the first axis, and five dielectric layers 11 located at each of the upper portion and the lower portion along the Z-axis that is the first axis are selected. In the case where the total number of the dielectric layers 11 is an even number, six layers may be selected from the center portion. For the selection of the layers to be measured, the dielectric layers 11 are selected from the capacitance portion 14.

A thickness of each of the selected dielectric layers 11 is measured at three positions, and the three positions are positions set apart from the end, which is with respect to the X-axis as the second axis, by ¼, ½, and ¾ of the length of the dielectric layers 11 along the X-axis. The average value of the measured thickness values is determined as the thickness of the given dielectric layer 11 selected and measured. In the same manner, the thickness values of all of the selected dielectric layers 11 are measured and evaluated, and an average value of the thickness values of all the evaluated dielectric layers 11 is determined as a thickness of each of the dielectric layers 11 of the evaluated multilayer ceramic capacitor 100.

### (3) Internal Electrode Layer

### (3-1) Components Included in Internal Electrode Layer

Each of the internal electrode layers 12 may include a base metal element as a main component. In addition to the base metal element serving as a main component, each of the internal electrode layers 12 may further include additive metal elements.

The internal electrode layers 12 may include any substances typically used in internal electrode layers of multilayer ceramic capacitors. In particular, each of the internal electrode layers 12 may include a base metal such as nickel (Ni), tin (Sn), tungsten (W), and the like, or an alloy including at least one selected from the group consisting of the foregoing base metals, as a main component, i.e., at the largest ratio based on the amount of substance relative to all substances included.

Since excellent electric characteristics are achieved, and cost can be reduced, each of the internal electrode layers 12 may include nickel as the base metal element, and may include nickel as a main component.

The main component for the first internal electrode layers 12a and the main component for the second internal electrode layers 12b may be same or different. As one example, the main component for both the first internal electrode layers 12a and the second internal electrode layers 12b may be nickel.

### (3-2) Thickness of Internal Electrode Layer

The thickness of each of the internal electrode layers 12 is not particularly limited. From the viewpoint of increase in a capacitance through increase in number of layers to be stacked, while reducing the size of the multilayer ceramic capacitor 100, the thickness of each of the internal electrode layers 12 is, for example, preferably 0.8 μm or less, and more preferably 0.6 μm or less.

The lower limit of the thickness of each of the internal electrode layers 12 is not particularly limited. In the case each of the internal electrode layers 12 is formed by printing a metal conductive paste through a printing method, such as screen printing, gravure printing, or the like, for example, the lower limit can be 0.4 μm or greater. In the case where each of the internal electrode layers 12 is formed by a thin-film formation process, such as sputtering, the lower limit can be 0.1 μm or greater, which is thinner than the case of the printing method.

In a similar manner to the evaluation of the thickness of each of the dielectric layers 11, the thickness of each of the internal electrode layers 12 is evaluated in the cross-section taken along the first axis that is the stacking direction. For example, the evaluation is performed in the cross-section taken along the second axis perpendicular to the stacking direction, as well as the first axis, or a cross-section taken along the third axis perpendicular to the stacking direction and to the second axis, as well as the first axis, in view of easiness of polishing and measuring.

Among the exposed internal electrode layers, five layers are selected from each of the center portion, the upper portion, and the lower portion of the multilayer ceramic capacitor 100 in the first axis direction. In the case where the total number of the internal electrode layers 12 is an even number, six layers are selected from the center portion. A thickness of each of the selected internal electrode layers 12 was measured at three positions in total, i.e., a center, a left side edge, and a right side edge, and an average value of the measured thickness values is determined as the thickness of the given internal electrode layer 12. Then, an average value of thickness values of all the selected and evaluated internal electrode layers 12 is determined as the thickness of each of the internal electrode layers 12 of the multilayer ceramic capacitor 100.

Since the first axis that is the stacking direction is the Z-axial direction in the example illustrated in FIGS. 1 and 2, the multilayer ceramic capacitor 100 is polished along the Y-axis that is the third axis to expose the XZ plane revealing the stacking of the dielectric layers 11 and the internal electrode layers 12.

In this case, within the exposed XZ plane, five internal electrode layers 12 located at the center portion along the Z-axis that is the first axis, and five internal electrode layers 12 located at each of the upper portion and the lower portion along the Z-axis that is the first axis are selected. In the case where the total number of the internal electrode layers 12 is an even number, six layers may be selected from the center portion. For the selection of the layers to be measured, the internal electrode layers 12 are selected from the capacitance portion 14.

A thickness of each of the selected internal electrode layers 12 is measured at three positions, and the three positions are positions away from the end, which is with respect to the X-axis that is the second axis, by ¼, ½, and ¾ of the length of the internal electrode layers 12 along the X-axis. The average value of the measured thickness values is determined as the thickness of the given internal electrode layer 12 selected and measured. In the same manner, the thickness values of all of the selected internal electrode layers 12 are measured and evaluated, and an average value of the thickness values of all the evaluated internal electrode layers 12 is determined as a thickness of each of the internal electrode layers 12 of the evaluated multilayer ceramic capacitor 100.

### (3) Side Margin

### (3-1) Secondary Phase

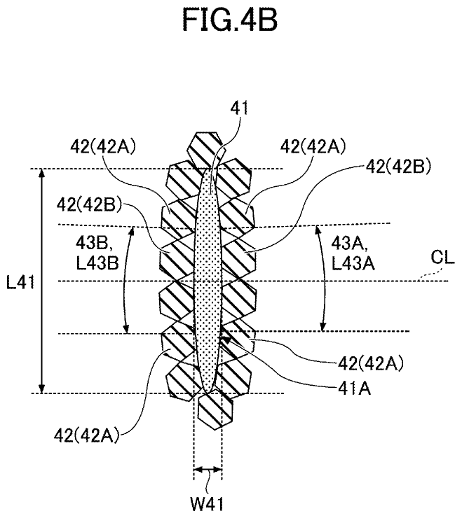

As illustrated in FIGS. 4A and 4B, the side margin 16 includes a dielectric material 42 and a secondary phase 41. FIG. 4A is an enlarged view of the region C of FIG. 3, and is a partially enlarged view of the side margin 16. FIG. 4B is a schematic view illustrating an arrangement of a particle of the secondary phase 41 and particles of the dielectric material 42 disposed around the particle of the secondary phase 41.

The inventors of the present disclosure have conducted the study on a multilayer ceramic electronic component having excellent moisture resistance, and have found that moisture resistance can be enhanced when the side margin 16 includes particles of the secondary phase 41, and an average number of the particles of the dielectric materials, which are in contact with a surface of each of the particles of the secondary phase 41 in the side margin 16 per 1 μm of the surface of the secondary phase 41, is within the predetermined range. The present invention has been accomplished based on the above insight of the present inventors.

In the present specification, excellent moisture resistance means that a failure rate in a moisture resistance test, which will be described in the evaluation method of Examples, is 2% or less.

The secondary phase 41 is formed of a material that is different from the dielectric material or the like included as a main component in the side margin 16. The secondary phase 41 may be, for example, additives added together with a raw material, which is the dielectric material or the like, at the time of firing of the side margin 16, or a reaction product of the additive and ceramic particles.

For example, the secondary phase 41 may include silicon (Si). In addition to silicon (Si), the secondary phase 41 may further include at least one selected from the group consisting of lithium (Li), boron (B), and calcium (Ca). The secondary phase 41 may further include aluminum (Al).

### (Arrangement of Particles of Dielectric Material and Particle of Secondary Phase)

The particles of the dielectric material 42 may be arranged to surround each of the particles of the secondary phase 41. For example, in the cross-sectional image taken along the first axis, the side margin 16 may include particles of the secondary phase 41 each having a surface of a length of 2 μm or greater. The average number of the particles of the dielectric material 42 in contact with the surface of each of the particles of the secondary phase 41 per 1 μm may be 0.5 or greater and 5 or less.

For example, as illustrated in FIG. 4B, a plurality of particles of the dielectric material 42 are arranged around a particle of the secondary phase 41. By setting the average number of the particles of the dielectric material 42 in contact with the surface of the particle of the secondary phase 41 per 1 μm to 0.5 or greater, the particles of the dielectric material 42 can be densely arranged around the particle of the secondary phase 41. Thus, it is assumed that the amount of moisture, which passes between the particles of the dielectric material 42 or passes between the particle of the secondary phase 41 and the particles of the dielectric material 42 to reach the capacitance portion 14 as observed in the related art, can be reduced, enhancing moisture resistance of the multilayer ceramic electronic component.

By setting the average number of the particles of the dielectric material 42 in contact with the surface of each of the particles of the secondary phase 41 per 1 μm to 5 or less, productivity of the multilayer ceramic electronic component can be increased.

The number of the particles of the dielectric material 42 in contact with the surface of each of the particles of the secondary phase 41 per 1 μm can be evaluated in the cross-section taken along the first axis and also along the third axis perpendicular to the stacking direction and to the second axis, and can be measured and calculated, for example, in the following manner.

For the evaluation, the multilayer ceramic electronic component is polished, for example, along the second axis to expose the YZ plane illustrated in FIG. 3.

Within the exposed cross-section, observation is performed on the side margin 16. As illustrated in FIG. 3, there are two side margins 16 with the capacitance portion 14 being interposed between the two side margins 16 in the exposed cross-section, and therefore observation is performed on the two side margins 16.

The secondary phase 41 and the dielectric material 42 are identified by difference in contrast, and optionally performing a composition analysis or the like by EDX.

Among the particles of the secondary phase 41 having the surface length of 2 μm or greater included in the side margins 16, 10 particles or more and 50 particles or less are selected. Then, in each of the selected particles of the secondary phase 41, two measurement regions in total, i.e., a first measurement region 43A and a second measurement region 43B, are set. The first measurement region 43A and the second measurement region 43B are provided on both side surfaces of each of the particles of the secondary phase 41, respectively, along the minor axis of each of the particles of the secondary phase 41.

The length L43A of the first measurement region 43A along the surface of the particle of the secondary phase 41 and the length L43B of the second measurement region 43B along the surface of the particle of the secondary phase 41 are both 1 μm. The first measurement region 43A and the second measurement region 43B are set so that the center of the first measurement region 43A and the center of the second measurement region 43B coincide with the center line CL passing through the center of the major axis of the particle of the secondary phase 41.

Then, the number of the particles of the dielectric material 42 in contact with each of the set measurement regions of the surface of the particle of the secondary phase 41 is counted. A particle 42A of the dielectric material 42 may be positioned on the boundary of each measurement region. In this case, the particle 42A that is positioned on the boundary and is not entirely located within each measurement region may not be counted. Specifically, in the case of the first measurement region 43A of FIG. 4B, two particles 42B of the dielectric material 42 are counted as being in contact with the region having the length L43A of 1 μm, which is set on the surface 41A of the particle of the secondary phase 41. The number of the particles of the dielectric material 42 in contact with the surface of the particle of the secondary phase 41 per 1 μm is measured on each of the first measurement region 43A and the second measurement region 43B of each of the selected particles of the secondary phase 41. Then, an arithmetic mean of the measured numbers is determined. The calculated arithmetic mean can be determined as the number of the particles of the dielectric material 42 in contact with the surface of each of the selected particles of the secondary phase 41 per 1 μm.

In the same manner, the number of the particles of the dielectric material 42 in contact with the surfaces of all of the selected particles of the secondary phase 41 per 1 μm is determined, and an arithmetic mean of the measured numbers is determined. The calculated arithmetic mean can be determined as an average number of the particles of the dielectric material 42 in contact with the surface of each of the particles of the secondary phase 41 per 1 μm in the multilayer ceramic electronic component.

The secondary phase 41 is distributed to fill the gaps between the particles of the dielectric material 42. By setting the average particle diameter of the particles of the dielectric material and the average particle diameter (average major axis diameter) of the particles of the secondary phase 41 within the predetermined ranges, voids in the side margin 16 can be reduced. Thus, it is assumed that the amount of moisture, which passes through the gaps between the particles of the dielectric material 42 to reach the capacitance portion 14 as observed in the related art, can be reduced so that moisture resistance of the multilayer ceramic electronic component can be particularly enhanced.

The average major axis diameter of the particles of the secondary phase 41 in the side margin 16 may be 2 μm or greater and 4 μm or less, 2.1 μm or greater and 3.9 μm or less, or 2.5 μm or greater and 3.9 μm or less.

The average major axis diameter of the particles of the secondary phase 41 can be evaluated in the cross-section taken along the first axis and also along the third axis perpendicular to the stacking direction and to the second axis, and can be measured and calculated in the following manner.

For the evaluation, the multilayer ceramic electronic component is polished, for example, along the second axis to expose the YZ plane illustrated in FIG. 3.

Within the exposed cross-section, observation is performed on the side margin 16. As illustrated in FIG. 3, there are two side margins 16 with the capacitance portion 14 being interposed between the two side margins 16 in the exposed cross-section, and therefore observation is performed on the two side margins 16.

The secondary phase 41 and the dielectric material 42 are identified by difference in contrast, and optionally performing a composition analysis or the like by EDX.

Among the particles of the secondary phase 41 in the side margins 16, 10 particles or more and 50 particles or less are selected, and a major axis L41 and a minor axis W41 (see FIG. 4B) of each of the selected particles of the secondary phase 41 are measured. The same number of the particles of the secondary phase 41 is preferably selected from each of the two side margins 16.

Then, an arithmetic mean of the major axes of all of the selected and measured particles of the secondary phase 41 and an arithmetic mean of the minor axes of all of the selected and measured particles of the secondary phase 41 are determined as the average major axis diameter and the average minor axis diameter of the particles of the secondary phase 41 included in the side margins 16 in the multilayer ceramic electronic component. A ratio of the major axis to the minor axis is calculated using the average values of the major axes and minor axes (average major axis diameter: average minor axis diameter), and the result can be determined as an aspect ratio of the particles of the secondary phase 41. Specifically, the aspect ratio of the particles of the secondary phase 41 can be determined by a ratio of the average major axis diameter to the average minor axis diameter.

The aspect ratio may be, for example, 4 or greater and 6 or less.

### (3-2) Dielectric Material

The side margin 16 may include a dielectric material 42.

As the dielectric material, the compound having the perovskite structure described in “(2) Dielectric layer” may be included. The dielectric material included in each of the dielectric layers 11 and the dielectric material included in each of the side margins 16 may be same or different.

### (Average Particle Diameter)

The average particle diameter of the particles of the dielectric material 42 included in the side margin 16 may be 0.15 μm or greater and 1.6 μm or less, 0.4 μm or greater and 1.1 μm or less, or 0.6 μm or greater and 0.9 μm or less.

The average particle diameter of the particles of the dielectric material 42 can be evaluated in a cross-section taken along the first axis and also along the third axis perpendicular to the stacking direction and to the second axis. For example, the average particle diameter of the particles of the dielectric material 42 can be measured and calculated in the following manner.

For the evaluation, the multilayer ceramic electronic component is polished, for example, along the second axis to expose the YZ plane illustrated in FIG. 3.

Within the exposed cross-section, observation is performed on the side margin 16. As illustrated in FIG. 3, there are two side margins 16 with the capacitance portion 14 being interposed between the two side margins 16 in the exposed cross-section, and therefore observation is performed on the two side margins 16.

The secondary phase 41 and the dielectric material 42 are identified by difference in contrast, and optionally performing a composition analysis or the like by EDX.

Among the particles of the dielectric material 42 in the side margins 16, 10 particles or more and 50 particles or less are selected, and the Heywood diameter of each of the selected particles of the dielectric material 42 (a diameter of a circle having an area equal to the area of the evaluated particle of the dielectric material) is measured and calculated. The same number of the particles of the dielectric material 42 is preferably selected from each of the two side margins 16.

Then, an arithmetic mean of the diameters of all of the selected and measured particles of the dielectric material 42 can be determined as an average particle diameter of the particles of the dielectric material 42 in the side margin 16 of the multilayer ceramic electronic component.

### (3-3) Porosity

The porosity of the side margin 16 is preferably small. The porosity may be, for example, 2% or less, 1.9% or less, or 1.3% or less.

A method of determining the porosity of the side margin 16 is not particularly limited, but can be measured and calculated, for example, in the following manner.

The porosity of the side margin 16 can be evaluated in the cross-section taken along the third axis perpendicular to the stacking direction and to the second axis, as well as the first axis, and can be measured and calculated in the following manner.

For the evaluation, the multilayer ceramic electronic component is polished, for example, along the second axis to expose the YZ plane illustrated in FIG. 3.

Within the exposed cross-section, observation is performed on the side margin 16. As illustrated in FIG. 3, there are two side margins 16 with the capacitance portion 14 being interposed between the two side margins 16 in the exposed cross-section, and therefore observation is performed on the two side margins 16.

A ratio of the area of the voids included in the side margins 16 in the observed cross-section of the side margins 16 is determined as the porosity of each of the side margins 16.

### (3-4) Thickness of Side Margin

In recent years, an improvement in capacitance of a multilayer ceramic electronic component has been desired, and therefore it is desired to reduce the thickness of the side margin 16.

However, reduction in the thickness of the side margin 16 causes a problem of reduction in moisture resistance of the multilayer ceramic electronic component.

Conversely, the multilayer ceramic electronic component of the present embodiment can improve a moisture resistance. Such an effect is significantly exhibited particularly when a thickness of the side margin 16 is small. Therefore, in the multilayer ceramic electronic component of the present embodiment, the thickness of the side margin 16 may be equal to or less than 15 μm, which is the thinnest side margin achieved in multilayer ceramic electronic components of the related art, and may be less than 15 μm. The thickness T16 of the side margin 16 may be 15 μm or less, less than 15 μm, 12 μm or less, or 10 μm or less. The lower limit of the thickness T16 of the side margin 16 is not particularly limited. For example, the lower limit of the thickness T16 may be 5 μm or greater, or 7 μm or greater.

The thickness of the side margin 16 can be evaluated in a cross-section taken along the first axis, and also along the third axis perpendicular to the stacking direction and to the second axis.

Among the exposed internal electrode layers 12, five layers are selected from each of the center portion, the upper portion, and the lower portion of the cross-section of the multilayer ceramic capacitor in the first axis direction. In the case where the total number of the internal electrode layers 12 is an even number, six layers are selected from the center portion. Then, the distance between each of ends of the selected internal electrode layers 12 and the outermost surface of the corresponding side margin 16, which is the third side surface 10c or the fourth side surface 10d, is measured as a thickness T16 of the side margin 16. The distance between the end of the internal electrode layer 12 and the outermost surface of the corresponding side margin 16 means the minimum distance between the end of the internal electrode layer 12 and the outermost surface of the corresponding side margin 16.

An average value of all the measured distances between the ends of the internal electrode layers 12 and the outermost surface of the corresponding side margin 16, which is the third side surface 10c or the fourth side surface 10d, can be determined as the thickness of the side margin 16 in the multilayer ceramic capacitor 100.

Since the first axis that is the stacking direction is the Z-axial direction in the example illustrated in FIGS. 1 and 3, the multilayer ceramic capacitor 100 is polished along the X-axis that is the second axis to expose the YZ plane revealing the stacking of the dielectric layers 11 and the internal electrode layers 12 in the illustrated example.

In this case, with the exposed YZ plane, five internal electrode layers 12 located at the center portion along the Z-axis that is the first axis, and five internal electrode layers 12 located at each of the upper portion and the lower portion along the Z-axis that is the first axis are selected. In the case where the total number of the internal electrode layers 12 is an even number, six layers may be selected from the center portion. For the selection of the layers to be measured, the internal electrode layers 12 are selected from the capacitance portion 14.

For each of the selected internal electrode layers 12, the distance between the end of each of the internal electrode layers 12 and the outermost surface of a corresponding side margin 16, which is the third side surface 10c or the fourth side surface 10d, is measured along the Y-axis that is the third axis. The average value of all the measured distances is determined as the thickness T16 of the side margin 16.

### [Production Method for Multilayer Ceramic Capacitor]

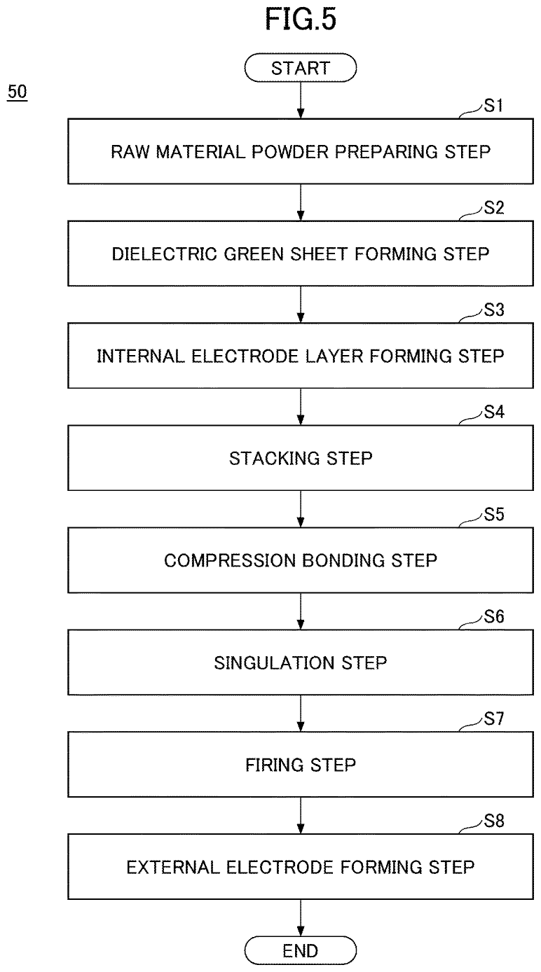

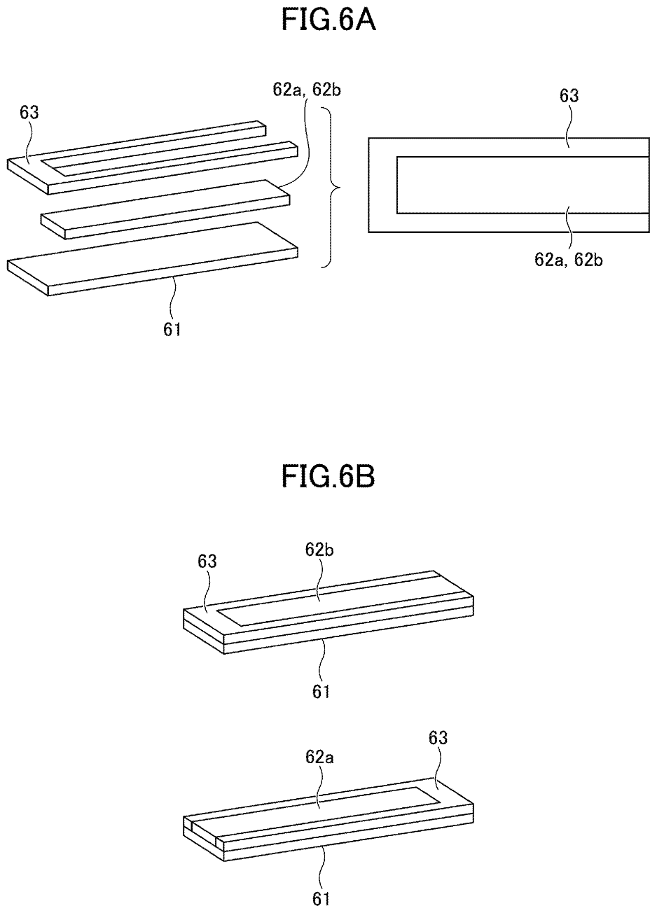

Next, a production method for the multilayer ceramic capacitor 100 will be described. FIG. 5 is a flowchart 50 illustrating an example of the production method for the multilayer ceramic capacitor 100. FIGS. 6A and 6B are views illustrating an example of the production method for the multilayer ceramic capacitor 100.

The production method for the multilayer ceramic capacitor of the present embodiment includes a dielectric green sheet forming step, an internal electrode layer pattern forming step, and a firing step. The production method for the multilayer ceramic capacitor of the present embodiment will be described hereinafter, together with optional steps other than the above steps.

### (1) Raw Material Powder Preparing Step (S1)

In the raw material powder preparing step, a raw material powder for forming dielectric layers 11 can be prepared.

Each of the dielectric layers 11 of the multilayer ceramic capacitor 100 produced by the production method for the multilayer ceramic capacitor of the present embodiment can include a dielectric material that is a compound having a perovskite structure represented by a general formula ABO_{3-α} (0≤α≤1). Since the compound having a perovskite structure represented by the general formula ABO_{3-α} (0≤α≤1) has been already described, redundant description will be omitted.

The A-site (element A) and the B-site (element B) of the dielectric material included in each of the dielectric layers 11 are generally included in the form of a sintered body of ABO_{3-α} (0≤α≤1) in each of the dielectric layers 11. For example, barium titanate is a tetragonal compound having a perovskite structure, and exhibits a high relative dielectric constant. Barium titanate can be generally obtained by reacting a titanium raw material, such as titanium dioxide, with a barium raw material, such as barium carbonate. As a synthesis method for the dielectric material used as a main component of the dielectric layers 11, various methods have been known. For example, a solid phase method, a sol-gel method, a hydrothermal method, and the like are known. In the present embodiment, any of the above methods can be used.

In the raw material powder preparing step, a predetermined additive compound may be added to the dielectric material according to the intended purpose. The additive compound serves as a raw material of the secondary phase. Thus, an additive compound corresponding to a target composition of the secondary phase can be added to the dielectric material. Since the secondary phase is included only in the side margin 16, the additive compound corresponding to a target composition of the secondary phase may be only added to a raw material powder used for the side margin 16.

Examples of the additive compound include: any of oxides, carbonates, or nitrides each including at least one element selected from the group consisting of zirconium (Zr), magnesium (Mg), manganese (Mn), molybdenum (Mo), vanadium (V), chromium (Cr), aluminum (Al), titanium (Ti), calcium (Ca), and rare-earth elements; any of oxides, carbonates, or nitrides each including at least one element selected from the group consisting of cobalt (Co), nickel (Ni), lithium (Li), boron (B), sodium (Na), potassium (K), and silicon (Si); glass including at least one element selected from the group consisting of cobalt, nickel, lithium, boron, sodium, potassium, and silicon; and the like.

Examples of the rare-earth elements include at least one selected from the group consisting of scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb).

The raw material powder can be prepared, for example, by wet mixing the dielectric material and the additive compound, and drying and pulverizing the mixture. The raw material powder is also described as a dielectric pattern material in the following description. For example, the raw material powder obtained as described above may be optionally subjected to pulverization to adjust the particle size, or subjected to pulverization in combination with classification to adjust the particles size. According to the above step, the raw material powder, which is a ceramic material, is obtained.

### (2) Dielectric Green Sheet Forming Step (S2)

In the dielectric green sheet forming step, a binder, such as a polyvinyl butyral (PVB) resin or the like, an organic solvent, such as ethanol, toluene, or the like, and a plasticizer are added to the raw material powder obtained at the raw material powder preparing step, and the resultant mixture is subjected to wet-mixing to obtain a slurry. Alternatively, a binder and the like are added at the time of mixing the raw material powder and the like at the raw material powder preparing step (S1), and the resultant mixture is wet mixed to form a slurry.

In the dielectric green sheet forming step, the obtained slurry is used and applied onto a base, for example, by die coating, doctor-blade coating, or the like, and the applied slurry is dried to form a dielectric green sheet 61. As the base, for example, a polyethylene terephthalate (PET) film can be used. A drawing that illustrates an example of the dielectric green sheet forming step is omitted.

Accordingly, at the dielectric green sheet forming step (S2), the dielectric green sheet that includes the compound having the perovskite structure represented by the general formula ABO_{3-α} (0≤α≥1), the additive compound, and the like can be formed. The dielectric green sheet may include the additive compound as described above, in addition to the dielectric compound having the perovskite structure represented by the general formula.

### (3) Internal Electrode Layer Forming Step (S3)

The first internal electrode layers 12a and the second internal electrode layer 12b can include, as a main component, at least one selected from the group consisting of base metals, such as nickel (Ni), tin (Sn), and tungsten (W), and alloys including the foregoing base metals.

The main component for the first internal electrode layers 12a and the main component for the second internal electrode layers 12b may be same or different. As one example, the main component for both the first internal electrode layer 12a and the second internal electrode layer 12b may be nickel.

A metal conductive paste for forming a precursor of the first internal electrode layers 12a and that of the second internal electrode layers 12b can be prepared by kneading the selected main component, an organic binder, and a solvent.

In the internal electrode layer forming step, as illustrated in FIG. 6A, the metal conductive paste for forming internal electrode layers, which include the organic binder, can be printed on the surface of the dielectric green sheet 61 by screen printing, gravure printing, or the like. As the organic binder, for example, ethyl cellulose (EC), a polyvinyl butyral (PVB) resin, or the like can be used. Thus, a first internal electrode layer pattern 62a for a first internal electrode layer 12a or a second internal electrode layer pattern 62b for a second internal electrode layer 12b is disposed on the surface of the dielectric green sheet 61. Various additives, such as a dispersant, and ceramic particles serving as a co-material may be added to the metal conductive paste. A main component for the ceramic particles is not particularly limited, but is preferably same as the main component for the dielectric layers 11. In the case where the ceramic particles are added as a co-material, the ceramic particles can be added at the time of kneading of the metal conductive paste. A formation method for the internal electrode layers is not limited to printing, and plating, vacuum vapor deposition, sputtering, CVD, or the like may be used.

In addition, to the dielectric pattern material obtained at the raw material powder preparing step, a binder, such as an ethyl cellulose-based binder or the like, and an organic solvent, such as a terpineol-based solvent or the like, are added, and the resultant mixture is kneaded by a roll mill to obtain a dielectric pattern paste for a reverse-pattern dielectric layer. Then, as illustrated in FIG. 6A, the dielectric pattern paste is printed on the peripheral region of the dielectric green sheet 61 where the internal electrode layer pattern had not been printed, to thereby dispose a dielectric pattern 63 to be level with the internal electrode layer pattern. The dielectric pattern 63 is also described as a reverse-pattern dielectric layer, and the step of forming the above-described reverse-pattern dielectric layer may be described as a reverse-pattern dielectric layer forming step. A part of the dielectric pattern 63 becomes a side margin 16. Therefore, substances serving as a raw material of a secondary phase included in the side margin 16 of the dielectric pattern 63 may be added. The dielectric pattern 63 may include, for example, the additive compound described as the material of the dielectric layers. Since the dielectric pattern 63 includes the additive compound, a secondary phase can be precipitated in the side margin 16 during the below-described firing step or after the firing step. Alternatively, particles corresponding to the secondary phase may be added to the dielectric pattern 63.

As described later, the side margin 16 may be formed after the firing step or before the firing step.

The dielectric green sheet 61 on which the internal electrode layer pattern and the dielectric pattern 63 have been printed is referred to as a laminate unit.

### (4) Stacking Step (S4)

In the stacking step, as illustrated in FIG. 6B, laminate units are stacked so that the internal electrode layers and the dielectric layers are alternately stacked, and the end edges of the internal electrode layers are alternately exposed to either end surface in the length direction of the dielectric layers to be alternately led to either of one pair of the external electrodes. Specifically, the dielectric green sheet 61 on which the first internal electrode layer pattern 62a and the dielectric pattern 63 have been printed, and the dielectric green sheet 61 on which the second internal electrode layer pattern 62b and the dielectric pattern 63 have been printed are sequentially stacked. For example, the number of the laminate units to be stacked can be 100 to 500.

### (5) Compression Bonding Step (S5)

In the compression bonding step, the predetermined number of cover sheets, for example, 2 to 10 cover sheets, are stacked on the top and bottom of the multilayer stack, in which the laminate units are stacked, respectively, and the resultant stack can be subjected to thermal compression bonding.

### (6) Singulation Step (S6)

In the singulation step, the bonded body obtained by the thermal compression bonding is processed into individual pieces to obtain a singulated multilayer stack. For the singulation method performed by dicing with a dicer or laser cutting, an existing method may be used as appropriate.

### (7) Firing Step (S7)

In the firing step, degreasing and firing of the singulated multilayer stack can be performed. At the firing step, a process of degreasing and a process of firing may be performed continuously or separately. The conditions for degreasing and firing are not particularly limited. For example, degreasing may be performed in a nitrogen atmosphere of 250° C. or higher and 500° C. or lower.

For example, firing may be performed in a weakly oxidizing atmosphere or reducing atmosphere at an oxygen partial pressure of 10⁻¹² atm or greater and 10⁻⁸ atm or less at a temperature in the range of 1,100° C. or higher and 1,350° C. or lower for 5 minutes or longer and 10 hours or shorter. The oxygen partial pressure may be preferably 10⁻¹² atm or greater and 10⁻¹⁰ atm or less.

In the case of the reducing atmosphere, at least one selected from the group consisting of hydrogen and carbon monoxide can be used as a reducing gas. The reducing gas may be used as a gas mixture with an inert gas, such as nitrogen, or a noble gas. Examples of the noble gas include helium and argon.

The temperature range at the time of firing may be preferably 1,150° C. or higher and 1,350° C. or lower. The firing time may be preferably 5 minutes or longer and shorter than 15 minutes.

### (8) External Electrode Forming Step (S8)

In the external electrode forming step, a metal conductive paste for forming external electrode layers, which includes a base metal serving as a main component, such as nickel, a metal, such as copper, and an organic binder is applied by screen printing, dipping, or the like, and the applied metal conductive paste is baked to form external electrodes. The formation method for the external electrodes is not limited to printing or dipping, and plating, vacuum vapor deposition, sputtering, or CVD may be used. In addition, the external electrodes may be formed by applying a conductive resin paste by screen printing, dipping, or the like, and curing the resin. As necessary, a layer of copper, nickel, or tin may be processed by plating. As described above, the first external electrode 20a and the second external electrode 20b can be formed. According to the above step, a multilayer ceramic capacitor 100 can be produced.

### (9) Side Margin Forming Step

As an optional step, the production method for the multilayer ceramic electronic component of the present disclosure may further include a side margin forming step. In this case, the constituent components of the multilayer ceramic capacitor are preferably formed in the regions excluding portions that will become a side margin, such as parts of the dielectric green sheets, the dielectric pattern 63, and the like, in the dielectric green sheet forming step (S2) and the internal electrode layer forming step (S3).

In the side margin forming step, a slurry for forming a side margin can be prepared by adding a binder, such as ethyl cellulose or the like, and an organic solvent, such as a terpineol-based solvent, to the dielectric pattern material obtained at the raw material powder preparing step. The slurry for forming the side margin may include an additive compound serving as a raw material of the secondary phase in addition to the dielectric pattern material and the like. The obtained slurry is used and applied onto a base, for example, by die coating or doctor blade coating, and the applied slurry is dried to form a dielectric green sheet for forming a side margin. As the base, for example, a polyethylene terephthalate (PET) can be used. Then, the dielectric green sheet for forming the side margin is joined with each of the portions corresponding to side margins of the multilayer stack singulated by the singulation step (S6), thereby forming side margins. After the side margin forming step, the resultant piece can be subjected to the firing step.

Alternatively, the paste for forming side margins may be applied to the portions of the multilayer stack, which has been subjected to the firing step, corresponding to side margins, and the applied paste is optionally fired, thereby forming side margins.

In the case where a secondary phase is formed in the firing step by adding the additive compound to the portions that will become side margins, an average major axis diameter of the particles, which will become the secondary phase, in the side margins can be adjusted according to a type or amount of the additive compound, firing conditions at the firing step, and the like.

The above steps are described as an example, and the production method for the multilayer ceramic capacitor of the present embodiment is not limited to the above embodiment. For example, base layers of external electrodes may be disposed on respective surfaces of the singulated multilayer stack, and the base layers of the external electrodes are fired and fixed to the multilayer stack at the same time as the firing of the ceramic, thereby forming the base layers. In this case, in the external electrode forming step performed after the firing, a layer of copper, nickel, or tin is formed on each of the base layers by plating, thereby forming external electrodes.

### Other Embodiments

Although the embodiments have been described above, the present disclosure is not limited to specific examples, and various modifications and changes can be made within the scope of the claims described.

For example, in the above embodiments, the present disclosure has been applied to the multilayer ceramic capacitor having two terminal electrodes, but the present disclosure may be applied to a multilayer ceramic capacitor having three or more terminals.

### EXAMPLES

Specific examples will be described hereinafter, but the present invention is not limited to the following examples.

### (1) Evaluation Method

### (1-1) Number of Particles of Dielectric Material Per 1 μm of Surface of Particle of Secondary Phase

The number of the particles of the dielectric material 42 in contact with the surface of each of the particles of the secondary phase 41 per 1 μm was evaluated in the cross-section taken along the first axis and also along the third axis perpendicular to the stacking direction and to the second axis.

For the evaluation, the multilayer ceramic capacitor was polished along the second axis to expose the YZ plane illustrated in FIG. 3.

Within the exposed cross-section, observation was performed on the side margin 16. As illustrated in FIG. 3, there were two side margins 16 with the capacitance portion 14 being interposed between the two side margins 16 in the exposed cross-section, and therefore observation was performed on the two side margins 16.

The secondary phase 41 and the dielectric material 42 were identified by difference in contrast, and performing a composition analysis by EDX as needed.

Among the particles of the secondary phase 41 having the surface length of 2 μm or greater included in the side margins 16, 30 particles were selected.

As illustrated in FIG. 4B, in each of the selected particles of the secondary phase 41, two measurement regions in total, i.e., a first measurement region 43A and a second measurement region 43B, were set. The first measurement region 43A and the second measurement region 43B were provided on both side surfaces of each of the particles of the secondary phase 41, respectively, along the minor axis of each of the particles of the secondary phase 41.

The length L43A of the first measurement region 43A along the surface of the particle of the secondary phase 41 and the length L43B of the second measurement region 43B along the surface of the the particle of the secondary phase 41 were both 1 μm. The first measurement region 43A and the second measurement region 43B were set so that the center of the first measurement region 43A and the center of the second measurement region 43B coincided with the center line CL passing through the center of the major axis of the particle of the secondary phase 41.

Then, the number of the particles of the dielectric material 42 in contact with each of the set measurement regions of the surface of the particle of the secondary phase 41 was counted. A particle 42A of the dielectric material 42 may be positioned on the boundary of each measurement region. In this case, the particle 42A that was positioned on the boundary and was not entirely located within each measurement region was not counted.

The number of the particles of the dielectric material 42 in contact with the surface of the particle of the secondary phase 41 per 1 μm was measured on each of the first measurement region 43A and the second measurement region 43B of each of the selected particles of the secondary phase 41. An arithmetic mean of the measured numbers was calculated. Then, the calculated arithmetic mean was determined as the number of the particles of the dielectric material 42 in contact with the surface of each of the selected particles of the secondary phase 41 per 1 μm.

In the same manner, the number of the particles of the dielectric material 42 in contact with the surfaces of all of the selected particles of the secondary phase 41 per 1 μm was determined, and an arithmetic mean of the measured numbers was determined. The calculated arithmetic mean was determined as the average number of the particles of the dielectric material 42 in contact with the surface of each of the particles of the secondary phase 41 per 1 μm in the evaluated multilayer ceramic electronic component.

### (1-2) Average Major Axis Diameter and Average Minor Axis Diameter of Particles of Secondary Phase, and Average Particle Diameter of Particles of Dielectric Material

The average major axis diameter and the average minor axis diameter of the particles of the secondary phase 41, and the average particle diameter of the particles of the dielectric material 42 were evaluated in the cross-section taken along the first axis, and also along the third axis set to be perpendicular to the stacking direction and to the second axis.

For the evaluation, the multilayer ceramic capacitor was polished along the second axis to expose the YZ plane illustrated in FIG. 3.

Within the exposed cross-section, observation was performed on the side margin 16. As illustrated in FIG. 3, there were two side margins 16 with the capacitance portion 14 being interposed between the two side margins 16 in the exposed cross-section, and therefore observation was performed on the two side margins 16.

The secondary phase 41 and the dielectric material 42 were identified by difference in contrast, and performing a composition analysis by EDX as needed.

Among the particles of the secondary phase 41 and the particles of the dielectric material 42 in the side margins 16, 30 particles of the secondary phase 41 and 30 particles of the dielectric material 42 were selected. The same number of the particles of the secondary phase 41 and the same number of the particles of the dielectric material were selected from each of the two side margins 16.

For each of the selected particles of the secondary phase 41, a major axis L41 and a minor axis W41 (see FIG. 4B) were measured. The arithmetic mean of the major axes and the arithmetic mean of the minor axes of all of the selected and measured particles of the secondary phase 41 were determined as an average major axis diameter and an average minor axis diameter of the particles of the secondary phase 41 in the evaluated multilayer ceramic capacitor.

The aspect ratio of the particles of the secondary phase was calculated from the average major axis diameter and the average minor axis diameter. Specifically, the aspect ratio was calculated according to the following equation:

Aspect ratio=average major axis diameter/average minor axis diameter

For the selected particles of the dielectric material 42, the Heywood diameters were measured and calculated, and the arithmetic mean of the Heywood diameters of all of the selected and measured particles of the dielectric material 42 was determined as an average particle diameter of the particles of the dielectric material 42 in the evaluated multilayer ceramic capacitor.

### (1-3) Porosity and Thickness of Side Margin

The porosity of the side margin 16 was evaluated in the cross-section taken along the first axis and also along the third axis perpendicular to the stacking direction and to the second axis.

For the evaluation, the multilayer ceramic electronic component was polished along the second axis to expose the YZ plane illustrated in FIG. 3.

Within the exposed cross-section, observation was performed on the side margin 16. As illustrated in FIG. 3, there were two side margins 16 with the capacitance portion 14 being interposed between the two side margins 16 in the exposed cross-section, and therefore observation was performed on the two side margins 16.

A ratio of the area of the voids in the side margins 16 in the observed cross-section of the side margins 16 was determined as the porosity of each of the side margins 16.

In addition, the thickness of each of the side margins 16 was evaluated in the above-described manner.

### (1-3) Evaluation and Determination of Moisture Resistance

A moisture resistance load test was performed on 1,000 multilayer ceramic capacitors produced under the same conditions in each of Examples and Comparative Examples.

Specifically, the multilayer ceramic capacitor produced in each of Examples and Comparative Examples was placed in a moisture-resistant tank, and a moisture resistance loading test was performed at a test temperature of 85° C. and relative humidity of 85% RH, with application of voltage of 10 Vdc (direct current) for 1,000 hours.

After the moisture resistance load test, the samples were immediately taken out from the moisture resistant tank, and the resistivity of each of the samples was measured when the temperature of each of the samples was returned to room temperature. Then, the resistivity of less than 25 MΩ was determined as a moisture resistance failure, and the failure rate was determined.

The failure rate in the moisture resistance load test is presented in the column of “Moisture resistance load test failure rate” in Table 1.

The moisture resistance load test failure rate of 0% or greater and 0.5% or less was judged as very good (VG), the moisture resistance load test failure rate of greater than 0.5% and 2% or less was judged as good (G), and the moisture resistance load test failure rate of greater than 2% was judged as not good (NG).

The moisture resistance is the highest with evaluation of “very good (VG)”, and the moisture resistance decreases in the order of “good (G)” and “not good (NG)”. The evaluation results of “very good (VG)” and “good (G)” indicate that a multilayer ceramic capacitor has an excellent moisture resistance.

### (2) Preparation Conditions of Sample

### Example 1

### (2-1) Raw Material Powder Preparing Step

A multilayer ceramic capacitor was produced according to the flowchart 50 illustrated in FIG. 5.

Specifically, a powder of barium titanate; holmium oxide (Ho₂O₃), magnesium oxide (MgO), manganese carbonate (MnCO₃), and silicon oxide (SiO₂) serving as additive compounds; a polyvinyl butyral (PVB) resin; a solvent; a plasticizer; and a dispersant were wet mixed to obtain a slurry.

### (2-2) Dielectric Green Sheet Forming Step

The obtained slurry was applied onto a base film, and the slurry applied onto the base film was dried to obtain a dielectric green sheet.

### (2-3) Internal Electrode Layer Forming Step

Next, a nickel powder serving as a main component metal element, ethyl cellulose (EC) or a polyvinyl butyral (PVB) resin serving as a binder, a solvent, and a plasticizer were wet mixed to obtain a metal conductive paste for forming internal electrode layers. The metal conductive paste was printed on a partial region of the surface of the dielectric green sheet, thereby forming an internal electrode layer pattern including, as a main component, nickel that was a base metal element with respect to the dielectric green sheet.

### (2-4) Reverse-Pattern Dielectric Layer Forming Step

Next, to the dielectric pattern material obtained at the raw material powder preparing step, silicon oxide (SiO₂), aluminum oxide (Al₂O₃), titanium oxide (TiO₂), a binder, such as an ethyl cellulose-based binder, and an organic solvent, such as a terpineol-based solvent were added. The resultant mixture was kneaded by a roll mill. By kneading the above materials, a dielectric pattern paste for reverse-pattern dielectric layers was obtained. Then, as illustrated in FIG. 6A, the dielectric pattern paste for reverse-pattern dielectric layers was printed on the peripheral region of the dielectric green sheet 61 to which the internal electrode layer pattern had not been printed, to provide a dielectric pattern 63, thereby forming a reverse-pattern dielectric layer.

By performing the dielectric green sheet forming step, the internal electrode layer forming step, and the reverse-pattern dielectric layer forming step described above, a laminate unit was produced. The obtained laminate unit included the dielectric green sheet, and the internal electrode layer pattern and the reverse-pattern dielectric layer formed on the surface of the dielectric green sheet.

### (2-5) Stacking Step

Next, 500 laminate units were stacked to form a multilayer stack.

### (2-6) Compression Bonding Step and Singulation Step

After compression bonding the multilayer stack, the resultant multilayer stack was processed into individual pieces to obtain a singulated chip-like green multilayer stack.

### (2-7) Firing Step

Next, degreasing was performed on the chip-like green multilayer stack in a nitrogen atmosphere of 500° C.

The metal conductive paste for base layers, which included a metal filler including nickel as a main component, a co-material, a binder, and a solvent, was applied onto the both end surfaces of the degreased green multilayer stack to extend to side surfaces, respectively, and the applied metal conductive paste was dried. Then, the green multilayer stack to which the base layers of external electrodes had been disposed, was placed in a firing furnace and was fired.

At the firing step, the oxygen partial pressure was 1.0×10⁻¹⁰ atm, and the firing temperature was retained at 1,220° C. for 300 seconds in a reducing atmosphere that was a hydrogen-nitrogen mixture atmosphere. At the time of heating, an amount of the green multilayer stack supplied or the oxygen partial pressure was adjusted so that a drastic change in the firing atmosphere was not caused by the gas generated from the green multilayer stack and cracks are not formed in the fired product.

### (2-7) External Electrode Forming Step

After the firing, a first external electrode 20a and a second external electrode 20b were formed on the multilayer stack by plating.

The obtained multilayer ceramic capacitor had a chip shape in the dimensions of 1.0 mm×0.5 mm×0.5 mm. In the obtained multilayer ceramic capacitor, the thickness of each of the dielectric layers 11 was 0.8 μm, the thickness of each of the internal electrode layers 12 was 0.6 μm, and the total number of the layers stacked was 500. The thickness of each of the dielectric layers 11 and the thickness of each of the internal electrode layers 12 were evaluated in the manner as described above.

The obtained multilayer ceramic capacitor was evaluated as described above. The evaluation results are presented in Table 1.

### Example 2

In the reverse-pattern dielectric layer forming step, to the dielectric pattern material obtained at the raw material powder preparing step, silicon oxide (SiO₂), aluminum oxide (Al₂O₃), calcium carbonate (CaCO₃), titanium oxide (TiO₂), a binder, such as an ethyl cellulose-based binder, and an organic solvent, such as a terpineol-based solvent, were added. The resultant mixture was kneaded by a roll mill. By kneading the above materials, a dielectric pattern paste for reverse-pattern dielectric layers was obtained. Then, as illustrated in FIG. 6A, the dielectric pattern paste for reverse-pattern dielectric layers was printed on the peripheral region of the dielectric green sheet 61 to which the internal electrode layer pattern had not been printed, to provide a dielectric pattern 63, thereby forming a reverse-pattern dielectric layer.

Except for the above, a multilayer ceramic capacitor was produced and evaluated in the same manner as in Example 1. The evaluation results are presented in Table 1.

### Example 3

In the reverse-pattern dielectric layer forming step, to the dielectric pattern material obtained at the raw material powder preparing step, silicon oxide (SiO₂), aluminum oxide (Al₂O₃), titanium oxide (TiO₂), manganese carbonate (MnCO₃), a binder, such as an ethyl cellulose-based binder, and an organic solvent, such as a terpineol-based solvent, were added. The resultant mixture was kneaded by a roll mill. By kneading the above materials, a dielectric pattern paste for reverse-pattern dielectric layers was obtained. Then, as illustrated in FIG. 6A, the dielectric pattern paste for reverse-pattern dielectric layers was printed on the peripheral region of the dielectric green sheet 61 to which the internal electrode layer pattern had not been printed, to provide a dielectric pattern 63, thereby forming a reverse-pattern dielectric layer.

Except for the above, a multilayer ceramic capacitor was produced and evaluated in the same manner as in Example 1. The evaluation results are presented in Table 1.

### Example 4

In the reverse-pattern dielectric layer forming step, to the dielectric pattern material obtained at the raw material powder preparing step, silicon oxide (SiO₂), aluminum oxide (Al₂O₃), magnesium oxide (MgO), titanium oxide (TiO₂), a binder, such as an ethyl cellulose-based binder, and an organic solvent, such as a terpineol-based solvent, were added. The resultant mixture was kneaded by a roll mill. By kneading the above materials, a dielectric pattern paste for reverse-pattern dielectric layers was obtained. Then, as illustrated in FIG. 6A, the dielectric pattern paste for reverse-pattern dielectric layers was printed on the peripheral region of the dielectric green sheet 61 to which the internal electrode layer pattern had not been printed, to provide a dielectric pattern 63, thereby forming a reverse-pattern dielectric layer.

Except for the above, a multilayer ceramic capacitor was produced and evaluated in the same manner as in Example 1. The evaluation results are presented in Table 1.

### Example 5

In the reverse-pattern dielectric layer forming step, to the dielectric pattern material obtained at the raw material powder preparing step, silicon oxide (SiO₂), aluminum oxide (Al₂O₃), lithium carbonate (Li₂CO₃), titanium oxide (TiO₂), a binder, such as an ethyl cellulose-based binder, and an organic solvent, such as a terpineol-based solvent, were added. The resultant mixture was kneaded by a roll mill. By kneading the above materials, a dielectric pattern paste for reverse-pattern dielectric layers was obtained. Then, as illustrated in FIG. 6A, the dielectric pattern paste for reverse-pattern dielectric layers was printed on the peripheral region of the dielectric green sheet 61 to which the internal electrode layer pattern had not been printed, to provide a dielectric pattern 63, thereby forming a reverse-pattern dielectric layer.

Except for the above, a multilayer ceramic capacitor was produced and evaluated in the same manner as in Example 1. The evaluation results are presented in Table 1.

### Example 6

In the reverse-pattern dielectric layer forming step, to the dielectric pattern material obtained at the raw material powder preparing step, silicon oxide (SiO₂), aluminum oxide (Al₂O₃), boron nitride (BN), titanium oxide (TiO₂), a binder, such as an ethyl cellulose-based binder, and an organic solvent, such as a terpineol-based solvent, were added. The resultant mixture was kneaded by a roll mill. By kneading the above materials, a dielectric pattern paste for reverse-pattern dielectric layers was obtained. Then, as illustrated in FIG. 6A, the dielectric pattern paste for reverse-pattern dielectric layers was printed on the peripheral region of the dielectric green sheet 61 to which the internal electrode layer pattern had not been printed, to provide a dielectric pattern 63, thereby forming a reverse-pattern dielectric layer.

Except for the above, a multilayer ceramic capacitor was produced and evaluated in the same manner as in Example 1. The evaluation results are presented in Table 1.

### Example 7

In the reverse-pattern dielectric layer forming step, to the dielectric pattern material obtained at the raw material powder preparing step, silicon oxide (SiO₂), aluminum oxide (Al₂O₃), magnesium oxide (MgO), titanium oxide (TiO₂), manganese carbonate (MnCO₃), a binder, such as an ethyl cellulose-based binder, and an organic solvent, such as a terpineol-based solvent, were added. The resultant mixture was kneaded by a roll mill. By kneading the above materials, a dielectric pattern paste for reverse-pattern dielectric layers was obtained. Then, as illustrated in FIG. 6A, the dielectric pattern paste for reverse-pattern dielectric layers was printed on the peripheral region of the dielectric green sheet 61 to which the internal electrode layer pattern had not been printed, to provide a dielectric pattern 63, thereby forming a reverse-pattern dielectric layer.

Except for the above, a multilayer ceramic capacitor was produced and evaluated in the same manner as in Example 1. The evaluation results are presented in Table 1.

### Example 8

In the reverse-pattern dielectric layer forming step, to the dielectric pattern material obtained at the raw material powder preparing step, silicon oxide (SiO₂), aluminum oxide (Al₂O₃), boron nitride (BN), titanium oxide (TiO₂), manganese carbonate (MnCO₃), a binder, such as an ethyl cellulose-based binder, and an organic solvent, such as a terpineol-based solvent, were added. The resultant mixture was kneaded by a roll mill. By kneading the above materials, a dielectric pattern paste for reverse-pattern dielectric layers was obtained. Then, as illustrated in FIG. 6A, the dielectric pattern paste for reverse-pattern dielectric layers was printed on the peripheral region of the dielectric green sheet 61 to which the internal electrode layer pattern had not been printed, to provide a dielectric pattern 63, thereby forming a reverse-pattern dielectric layer.

Except for the above, a multilayer ceramic capacitor was produced and evaluated in the same manner as in Example 1. The evaluation results are presented in Table 1.

### Comparative Example 1

In the reverse-pattern dielectric layer forming step, to the dielectric pattern material obtained at the raw material powder preparing step, silicon oxide (SiO₂), titanium oxide (TiO₂), a binder, such as an ethyl cellulose-based binder, and an organic solvent, such as a terpineol-based solvent, were added. The resultant mixture was kneaded by a roll mill. By kneading the above materials, a dielectric pattern paste for reverse-pattern dielectric layers was obtained. Then, as illustrated in FIG. 6A, the dielectric pattern paste for reverse-pattern dielectric layers was printed on the peripheral region of the dielectric green sheet 61 to which the internal electrode layer pattern had not been printed, to provide a dielectric pattern 63, thereby forming a reverse-pattern dielectric layer.

Except for the above, a multilayer ceramic capacitor was produced and evaluated in the same manner as in Example 1. The evaluation results are presented in Table 1.

### Comparative Example 2

In the reverse-pattern dielectric layer forming step, to the dielectric pattern material obtained at the raw material powder preparing step, silicon oxide (SiO₂), aluminum oxide (Al₂O₃), calcium carbonate (CaCO₃), lithium carbonate (Li₂CO₃), boron nitride (BN), titanium oxide (TiO₂), a binder, such as an ethyl cellulose-based binder, and an organic solvent, such as a terpineol-based solvent, were added. The resultant mixture was kneaded by a roll mill. By kneading the above materials, a dielectric pattern paste for reverse-pattern dielectric layers was obtained. Then, as illustrated in FIG. 6A, the dielectric pattern paste for reverse-pattern dielectric layers was printed on the peripheral region of the dielectric green sheet 61 to which the internal electrode layer pattern had not been printed, to provide a dielectric pattern 63, thereby forming a reverse-pattern dielectric layer.

Except for the above, a multilayer ceramic capacitor was produced and evaluated in the same manner as in Example 1. The evaluation results are presented in Table 1.

TABLE 1

| | Average number of | Average major | Aspect ratio of | Average | | | Heat | |
|---|---|---|---|---|---|---|---|---|
| | dielectric material | axis | secondary phase | particle | | Thickness | resistance | |
| | particles in contact | diameter of | particles (average | diameter of | | of | load test | |
| | with secondary | secondary | major axis diameter/ | dielectric | | side | failure | |
| | phase particle per | phase particles | average minor axis | material | Porosity | margin | rate | |
| | 1 μm (particles) | (μm) | diameter) | particles (μm) | (%) | (μm) | (%) | Judgement |
| Ex. 1 | 4.8 | 2.1 | 4.0 | 0.18 | 1.9 | 6.2 | 1.5 | G |
| Ex. 2 | 2.4 | 3.4 | 5.2 | 1.43 | 0.4 | 8.4 | 0.0 | VG |
| Ex. 3 | 3.2 | 2.6 | 4.3 | 0.81 | 0.7 | 7.5 | 0.0 | VG |
| Ex. 4 | 4.1 | 2.8 | 4.5 | 0.26 | 1.4 | 11.8 | 1.0 | G |
| Ex. 5 | 1.4 | 3.9 | 6.0 | 0.69 | 0.3 | 12.8 | 0.0 | VG |
| Ex. 6 | 0.7 | 2.3 | 4.1 | 1.44 | 1.6 | 15.7 | 1.0 | G |
| Ex. 7 | 1.3 | 3.2 | 4.9 | 0.78 | 1.2 | 14.5 | 0.5 | VG |
| Ex. 8 | 1.1 | 3.5 | 4.8 | 1.06 | 0.9 | 9.2 | 0.0 | VG |
| Comp. | 0.4 | 1.9 | 3.2 | 1.86 | 3.3 | 10.9 | 5.0 | NG |
| Ex. 1 | | | | | | | | |
| Comp. | 5.4 | 4.1 | 7.1 | 0.19 | 1.9 | 16.9 | 3.0 | NG |
| Ex. 2 | | | | | | | | |

It could be confirmed from Table 1 that the multilayer ceramic capacitors having an excellent moisture resistance could be obtained in Examples 1 to 8, in which the average number of the particles of the dielectric material in contact with the surface of each of the particles of the secondary phase per 1 μm in the side margins 16 was in the predetermined range of 0.5 or greater and 5 or less. In particular, it was confirmed that the multilayer ceramic capacitor having a particularly excellent moisture resistance could be obtained when the average number of the the particles of the dielectric material in contact with the surface of each of the particles of the secondary phase per 1 μm in the side margins 16 was 1 or greater and 4 or less.

In addition, considering the average major axis diameter of the particles of the secondary phase, it could be confirmed that the multilayer ceramic capacitor having an excellent moisture resistance was obtained when the average major axis diameter of the particles of the secondary phase was 2 μm or greater and 4 μm or less. Further, it could be confirmed that the multilayer ceramic capacitor having an excellent moisture resistance was obtained when the aspect ratio was 4 to 6.

For example, embodiments of the present disclosure include as follows.

<1> A multilayer ceramic electronic component includes a base body in which dielectric layers and internal electrode layers are alternately stacked along a first axis, wherein the internal electrode layers are led to an outside of the base body from either end of the base body along a second axis perpendicular to the first axis, the base body has a side margin at both ends of the base body, the both ends of the base body being along a third axis perpendicular to the first axis and to the second axis, and in a cross-sectional image of the multilayer ceramic electronic component taken along the first axis, the side margin includes particles of a secondary phase and particles of a dielectric material, where each of the particles of the secondary phase has a surface of a length of 2 μm or greater, and an average number of the particles of the dielectric material in contact with the surface of each of the particles of the secondary phase per 1 μm is 0.5 or greater and 5 or less.

<2> In the multilayer ceramic electronic component according to <1>, an average particle diameter of the particles of the dielectric material in the side margin is 0.15 μm or greater and 1.6 μm or less, and an average major axis diameter of the particles of the secondary phase in the side margin is 2 μm or greater and 4 μm or less, and wherein the side margin has a porosity of 2% or less.

<3> In the multilayer ceramic electronic component according to <1> or <2>, the side margins has a thickness of 15 μm or less.

<4> In the multilayer ceramic electronic component according to any one of <1> to <3>, each of the dielectric layers includes a compound having a perovskite structure that includes an element A and an element B and is represented by a general formula ABO_{3-α} (0≤α≤1), and each of the internal electrode layers includes a base metal element.

According to the present disclosure, there can be provided a multilayer ceramic electronic component having excellent moisture resistance.

What is claimed is:

1. A multilayer ceramic electronic component, comprising:
a base body in which dielectric layers and internal electrode layers are alternately stacked along a first axis,
wherein the internal electrode layers are led to an outside of the base body from either end of the base body along a second axis perpendicular to the first axis,
the base body has a side margin at both ends of the base body, the both ends of the base body being along a third axis perpendicular to the first axis and to the second axis, and
in a cross-sectional image of the multilayer ceramic electronic component taken along the first axis, the side margin includes particles of a secondary phase and particles of a dielectric material, where each of the particles of the secondary phase has a surface of a length of 2 μm or greater, and an average number of the particles of the dielectric material in contact with the surface of each of the particles of the secondary phase per 1 μm is 0.5 or greater and 5 or less.

2. The multilayer ceramic electronic component according to claim 1,
wherein an average particle diameter of the particles of the dielectric material in the side margin is 0.15 μm or greater and 1.6 μm or less, and an average major axis diameter of the particles of the secondary phase in the side margin is 2 μm or greater and 4 μm or less, and
wherein the side margin has a porosity of 2% or less.

3. The multilayer ceramic electronic component according to claim 1,
wherein the side margin has a thickness of 15 μm or less.

4. The multilayer ceramic electronic component according to claim 1,
wherein each of the dielectric layers includes a compound having a perovskite structure that includes an element A and an element B and is represented by a general formula ABO_{3-α} (0≤α≤1), and
each of the internal electrode layers includes a base metal element.
